(19) United States
(12) Patent Application Publication
(10) Pub. No.: US 2023/0124152 A1
(43) Pub. Date: Apr. 20, 2023

(54) METHOD AND APPARATUS FOR ACQUIRING EIGENSTATE OF QUANTUM SYSTEM, DEVICE, AND STORAGE MEDIUM

(71) Applicants: Shenzhen Tencent Computer Systems Company Limited, Shenzhen (CN); ZHEJIANG UNIVERSITY, Hangzhou (CN)

(72) Inventors: Jianlan WU, Shenzhen (CN); Yi YIN, Shenzhen (CN); Ze ZHAN, Shenzhen (CN)

(73) Assignees: Shenzhen Tencent Computer Systems Company Limited, Shenzhen (CN); ZHEJIANG UNIVERSITY, Hangzhou (CN)

(21) Appl. No.: 18/078,234

(22) Filed: Dec. 9, 2022

Related U.S. Application Data
(63) Continuation of application No. PCT/CN2021/134932, filed on Dec. 2, 2021.

(30) Foreign Application Priority Data
Sep. 26, 2021 (CN) 202111130173.1

(51) Int. Cl. G06N 10/60

(52) U.S. Cl. CPC G06N 10/60

(57) ABSTRACT

A method for acquiring an eigenstate of a quantum system includes performing cluster division on multiple particles included in a target quantum system to obtain multiple clusters, where each cluster includes one or more particles, obtaining multiple direct product states according to eigenstates respectively corresponding to the multiple clusters, selecting some direct product states from the multiple direct product states as a set of basis vectors to represent a compressed Hilbert space, acquiring a Hamiltonian of the target quantum system and an equivalent Hamiltonian in the compressed Hilbert space, and acquiring an eigenstate and eigenenergy of the equivalent Hamiltonian as an eigenstate and eigenenergy of the target quantum system.

### CROSS-REFERENCE TO RELATED APPLICATIONS

This application is a continuation application of International Application No. PCT/CN2021/134932, filed on Dec. 02, 2021, which claims priority to Chinese Patent Application No. 202111130173.1, filed with the China National Intellectual Property Administration on Sep. 26, 2021, the disclosures of each of which being incorporated by reference herein in their entireties.

### FIELD

The disclosure relates to the field of quantum technologies, and in particular, to a method and an apparatus for acquiring an eigenstate of a quantum system, a device, and a storage medium.

### BACKGROUND

With the rapid development of quantum computation, quantum algorithms have important applications in many fields. Solving the eigenstate and eigenenergy of a quantum system is a quite critical issue.

In the related art, a quantum eigenstate solving algorithm based on a variational method is provided. For any quantum system, a tentative wave function can be designed, and the minimum value of the corresponding energy, that is, the ground state energy and ground state, can be found by constantly changing the tentative wave function. Similarly, a first excited state of the quantum system is a state corresponding to the lowest energy in a wave function orthogonal to the ground state. After the ground state is determined, the first excited state can be found in a state space orthogonal to the ground state. A second excited state is a state corresponding to the lowest energy in the wave function orthogonal to the ground state and the first excited state, and so on. Theoretically, all eigenstates of the quantum system can be found by this method.

In order to implement time-dependent evolution of states on a quantum device, it is necessary to digitize a time-dependent evolution equation of states and transform an evolution matrix of states into a corresponding quantum gate operation on the quantum device. In the digitization process, the required quantum gate operation increases rapidly with the increase of the qubit number. Therefore, more resources required for computing, and the advantage of quantum algorithms is weakened.

### SUMMARY

According to various embodiments, a method for acquiring an eigenstate of a quantum system, performed by a computer device, may include: performing cluster division on multiple particles included in a target quantum system to obtain multiple clusters, each of the multiple clusters including at least one particle; obtaining multiple direct product states according to eigenstates respectively corresponding to the multiple clusters; selecting some direct product states from the multiple direct product states as a set of basis vectors to represent a compressed Hilbert space, a dimension number of the compressed Hilbert space being less than that of an original Hilbert space of the target quantum system; acquiring a Hamiltonian of the target quantum system and an equivalent Hamiltonian in the compressed Hilbert space; and acquiring an eigenstate and eigenenergy of the equivalent Hamiltonian as an eigenstate and eigenenergy of the target quantum system.

According to various embodiments, an apparatus for acquiring an eigenstate of a quantum system, a computer device, a non-transitory computer-readable storage medium, and a computer program product or a computer program consistent with the method may also be provided.

### BRIEF DESCRIPTION OF THE DRAWINGS

To describe the technical solutions of example embodiments of this disclosure more clearly, the following briefly introduces the accompanying drawings for describing the example embodiments. The accompanying drawings in the following description show only some embodiments of the disclosure, and a person of ordinary skill in the art may still derive other drawings from these accompanying drawings without creative efforts. In addition, one of ordinary skill would understand that aspects of example embodiments may be combined together or implemented alone.

FIG. 1 is a flowchart of a method for acquiring an eigenstate of a quantum system according to some embodiments.

FIG. 2 is a flowchart of a method for acquiring an eigenstate of a quantum system according to some embodiments.

FIG. 3 is a schematic diagram of a cluster division manner according to some embodiments.

FIG. 4 is a schematic diagram of a cluster division manner according to some embodiments.

FIG. 5 is a flowchart of a method for acquiring an eigenstate of a quantum system according to some embodiments.

FIG. 6 is a schematic diagram of ground state accuracy according to some embodiments.

FIG. 7 is a schematic diagram of eigenenergy accuracy according to some embodiments.

FIG. 8 is a block diagram of an apparatus for acquiring an eigenstate of a quantum system according to some embodiments.

FIG. 9 is a block diagram of an apparatus for acquiring an eigenstate of a quantum system according to some embodiments.

FIG. 10 is a structural block diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict.

According to some embodiments, a target quantum system is divided into the multiple clusters, the eigenstates of the multiple clusters are acquired to obtain the multiple direct product states, and some direct product states are selected from the plurality of direct product states to construct the compressed Hilbert space, which reduces the dimension number of the Hilbert space. The eigenstate solving problem of the Hamiltonian of the high-dimensional system with multi-bit interaction is split into eigenstate solving problems of multiple low-dimensional Hamiltonians, so as to construct the compressed Hilbert space. The equivalent Hamiltonian of the Hamiltonian of the target quantum system in the compressed Hilbert space is calculated to obtain the eigenvalue and eigenenergy of the equivalent Hamiltonian as the eigenvalue and eigenenergy of the target quantum system. Because the dimension number of the compressed Hilbert space is less than that of the original Hilbert space of the target quantum system, in the digitization process, it is avoided that the required quantum gate operation increases rapidly with the increase of the dimensions of the system, and that the number of gates for implementing multi-bit interaction increases rapidly with the increase of the dimensions of interaction, thereby reducing the calculation amount required for acquiring the eigenstates.

Before some embodiments are introduced and described, some terms involved in the disclosure are first explained and described.
1. Quantum computation: a computing manner based on quantum logic, and a basic unit for storing data is a qubit.
2. Qubit: a basic unit of quantum computation. A classical computer uses 0 and 1 as basic units of binary. Differently, the quantum computation can simultaneously process 0 and 1, and a system can be in a linear superposition state of 0 and 1: |ψ〉 = α|0〉 + β|1〉, α and β represent complex probability amplitude of the system at 0 and 1. Their modulus squares |α|² and |β|² respectively represent a probability at 0 and 1.
3. Hamiltonian: a Hermitian conjugate matrix describing a total energy of a quantum system. Hamiltonian is a physical word, an operator describing a total energy of a system, usually denoted by H.
4. Quantum state: in quantum mechanics, a quantum state is a microscopic state determined by a set of quantum numbers.
5. Eigenstate: for a Hamiltonian matrix H, a solution satisfying the equation: H(υ) = E (ψ) is referred to as an eigenstate |ψ〉of H, with eigenenergy E. A ground state corresponds to the lowest energy eigenstate of a quantum system.
6. Cluster: a set composed of multiple particles. In the field of physics, the particle in some embodiments may also be referred to as a spin. In addition, the qubit is a basic unit in quantum computation. One qubit can be used to simulate one particle/spin in a physical system or multiple qubits to simulate one particle/spin.
7. Eigenstate: in quantum mechanics, possible values of a mechanical quantity are all eigenvalues of its operators. A state described by an eigenfunction is referred to as an eigenstate of the operator. In its own eigenstate, the mechanical quantity takes a certain value, that is, the eigenvalue to which the eigenstate belongs.
8. Direct product state: in quantum mechanics, a state (state vector) of a system can be expressed by a function, which is referred to as “state function” (it can be understood as either a function or a vector, and there is no contradiction between the two). The state function of a single particle system is a unary function, and the state function of a multi-particle system is a multivariate function. If the multivariate function can separate variables, that is, the multivariate function can be written as a direct product of multiple unary functions, which is referred to as a “direct product state”.
9. First excited state: an energy-minimum excited state in excited states.
10. Diagonalization: a diagonal matrix refers to a matrix with non-zero elements only on a main diagonal, that is, an n×n matrix M is known, and if Mᵢⱼ=0 for i ≠j, the matrix is a diagonal matrix. If there is a matrix A and the result of A⁻¹MA is the diagonal matrix, the Matrix A diagonalizes the Matrix M.
11. Second quantization: a method for dealing with an identical particle system in a symmetric Hilbert space by using a generation operator and an elimination operator, which is usually referred to as a quadratic quantization method.
12. Hilbert space: refers to a complete inner product space.
13. Spin: an intrinsic motion caused by intrinsic angular momentum of particles. In the quantum mechanics, spin is an intrinsic property of particles, and operation rules of the spin are similar to angular momentum in classical mechanics, thereby generating a magnetic field.
14. Quantum gate: in quantum computation, especially in the computation model of quantum circuits, a quantum gate (or a quantum logic gate) is a basic quantum circuit operating a small qubit number.
15. Quantum eigenstate solving algorithm based on a variational method: for a Hamiltonian H of any physical system, supposing that the physical system includes a common eigenstate of a complete set of mechanical quantities including H is{|φᵢ〉}, a corresponding energy eigenvalue is E₀<E₁<E₂<..., where E₀ is a ground state energy and φ₀ is a ground state wave function. A tentative wave function
$$\left|φ\right〉 = \sum {}_{\text{i}} {a}_{\text{i}} \left|{φ}_{\text{i}}\right〉$$
can be designed, which corresponds to an energy
$$\frac{〈 \left(φ\right| \left(H\right| ϕ 〉}{〈 \left(ϕ\right| ϕ 〉} = \frac{{\sum }_{i} {\left|a \left({}_{i}\right|\right)}^{2} {E}_{i}}{{\left|a \left({}_{i}\right|\right)}^{2}} ⩾ {E}_{0}$$
. When and only when |φ〉 = |φ₀〉, the equal sign can be taken. Therefore, the minimum value of the corresponding energy, that is, the ground state energy and the ground state wave function, can be found by constantly changing the tentative wave function. Similarly, a first excited state of a system is a state corresponding to the lowest energy in the wave function orthogonal to the ground state |φ₀〉 . After the ground state is determined, the first excited state can be found in a state space orthogonal to the ground state. A second excited state is a state corresponding to the lowest energy in the wave function orthogonal to the ground state and the first excited state, and so on. Theoretically, all eigenstates of the system can be found by this method.
16. Quantum eigenstate solving algorithm based on an adiabatic approximation: adiabatic approximation means that if a perturbation acts on the physical system slowly enough, the instantaneous eigenstate of the physical system can be regarded as constant. Therefore, if the Hamiltonian of the physical system can be changed slowly enough, the physical system always evolves with the instantaneous eigenstate of the physical system. Therefore, a known eigenstate corresponding to a simple Hamiltonian on a quantum device can be constructed, and then the known eigenstate is evolved slowly enough to the Hamiltonian of the physical system of interest in solving. In this case, a quantum state obtained by measuring the quantum device is the eigenstate corresponding to the Hamiltonian to be solved.
17. Quantum eigenstate solving algorithm based on an adiabatic shortcut: adiabatic approximation requires the system to evolve slowly enough. On a basis of the adiabatic approximation, fast adiabatic term can be introduced to accelerate the evolution of the system and evolve to the target eigenstate in a shorter time.
18. Leapfrog quantum eigenstate solving algorithm that combines the adiabatic approximation and the adiabatic shortcut: for any target system, one or a set of reference points with the form similar to a Hamiltonian of the target system but relatively small coupling strength can be constructed. If it is attempted to evolve to the reference point with the relatively small coupling strength from a known eigenstate corresponding to a simple Hamiltonian, a form of fast insulation term of the reference point is relatively simple, and an eigenstate of the reference point can be easily solved by a quantum eigenstate solving algorithm based on fast adiabatic. Then, the quantum eigenstate solving algorithm based on adiabatic approximation is used to evolve the eigenstate of the reference point to an eigenstate of the next reference point or the target system. Because the Hamiltonian of the reference point is relatively close to that of the target system, adiabatic approximation can be implemented in less time (operations).

In a common multi-electron quantum system, a Hamiltonian of the quantum system after the second quantization can be expressed as formula (1).

$$H = {ε}_{0} + {\sum }_{i j} {V}_{i j} {}^{\left(2\right)} {a}_{i}^{+} {a}_{j} + {\sum }_{i j k l} {V}_{i j k l} {}^{\left(4\right)} {a}_{i}^{+} {a}_{j}^{+} {a}_{k} {a}_{l}$$

aᵢ and

$${a}_{i}^{+}$$

are the generation operator and the elimination operator on an i^{th} ground electronic state. aⱼ,

$${a}_{j}^{+} ,$$

aₖ, and aₗ can be explained in the same way, they satisfy

$${[ {a}_{i} , {a}_{j}^{+} ]}_{+} = {δ}_{\{ i , j \}}$$

, where [x,y] + is an anti-easy operator and δ_{{i,j}} is a jump operator. When i=j, δ_{{i,j}} = 1, and when i ≠ j, δ_{{i,j}} = 0.

$${V}_{i j}^{\left(2\right)}$$

and

$${V}_{i j k l}^{\left(4\right)}$$

are integral coefficients of single electron and double electron, and ε₀ is the ground state energy of the Hamiltonian. Through a mapping theory between fermions and spins, such as Bravyi-Kitaev transformation or Jordan-Wigner transformation, a Hamiltonian of the multi-electron quantum system can be rewritten into a multi-spin Hamiltonian, as shown in formula (2).

$$\begin{matrix}H = {g}^{\left(0\right)} + {\sum }_{i = 1}^{N} {\sum }_{a = 1}^{3} {g}_{i ; a}^{\left(1\right)} {σ}_{i}^{a} + {\sum }_{i , j = 1}^{N} {\sum }_{a , b = 1}^{3} {g}_{i j ; a b}^{\left(2\right)} {σ}_{j}^{a} {σ}_{j}^{b} + \\ {\sum }_{i , j , k = 1}^{N} {\sum }_{a , b , c = 1}^{3} {g}_{i j k ; a b c}^{\left(3\right)} {σ}_{i}^{a} {σ}_{j}^{b} {σ}_{k}^{c} + ...\end{matrix}$$

$$\left\{{σ}_{i}^{a} = {X}_{i} , {Y}_{i} , {Z}_{i}\right\}$$

is a Pauli matrix on an i^{th} spin,

$$\left\{{σ}_{j}^{b}\right\}$$

and

$$\left\{{σ}_{k}^{c}\right\}$$

can be explained in the same way, and {g⁽⁰⁾,g⁽¹⁾,g⁽²⁾,...} is a coefficient used to express the multi-spin interaction strength. In order to better reflect the applicability, the expression of the Hamiltonian is not truncated in 4 spin interaction terms (corresponding to formula (1)), but it is allowed to consider any

$$N ' \left(⩽ N\right)$$

spin interaction terms.

In order to solve an eigenstate |Ψₙ〉 and eigenenergy Eₙ of the Hamiltonian in formula (1), generally, a diagonalization tool in a 2^{N}-dimensional Hilbert space is needed. Instead, a method for acquiring an eigenstate of a quantum system is proposed, which can implement an approximate but accurate diagonalization solution in a highly compressed space.

Before the method provided in some embodiments are introduced, an execution environment of the method is first introduced and described.

The method for acquiring an eigenstate of a quantum system according to some embodiments can be implemented by a classic computer (such as a PC). For example, the classic computer is used to execute a corresponding computer program to implement the method. In some embodiments, the method may be performed in a hybrid device environment of a classic computer and a quantum computer. For example, the method is implemented through a cooperation of the classic computer and the quantum computer. For example, the quantum computer is configured to implement a solution of eigenstates of multiple clusters and a solution of eigenstates of an equivalent Hamiltonian in some embodiments, and the classic computer is configured to implement other operations than eigenstate solving problems in some embodiments.

In the following method embodiments, for ease of description, the description is provided by merely using a computer device as the execution entity of the operations. It is to be understood that the computer device may be a classic computer or may be a hybrid execution environment including a classic computer and a quantum computer. This is not limited in herein.

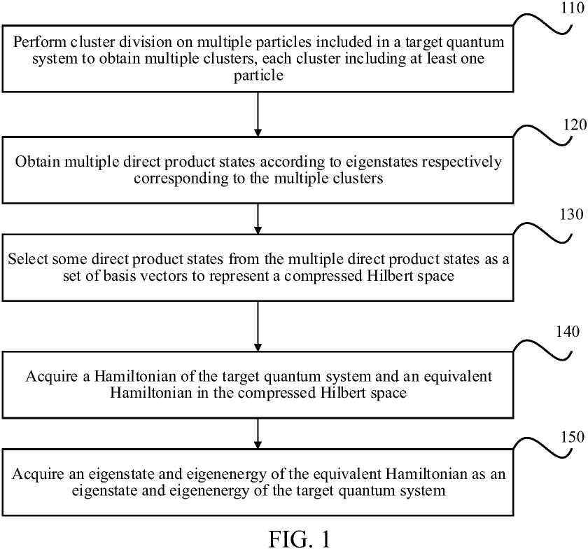

FIG. 1 is a flowchart of a method for acquiring an eigenstate of a quantum system according to some embodiments. The execution entity of the operations of the method may be the computer device. The method may include at least one of the following operations (110 to 150).

Operation 110. Perform cluster division on multiple particles included in a target quantum system to obtain multiple clusters, each cluster including at least one particle.

In some embodiments, cluster division is performed on multiple particles included in a target quantum system to obtain multiple clusters. Each cluster includes one or more particles of the target quantum system, and different clusters do not include the same particles. A sum of the number of particles included in the obtained multiple clusters is equal to the total number of particles included in the target quantum system.

The target quantum system refers to a quantum system whose eigenstate is to be acquired. In some embodiments, there are multiple cluster division manners. For example, it is assumed that a quantum system with N particles can be divided into two clusters, each including N₁ and N₂ particles, and N₁+N₂=N. For a given value of N₁, the number of alternative manners for such cluster division can be calculated by permutation and combination, and the maximum is

$${M}_{max} = {C}_{N}^{{N}_{1}} .$$

For example, if the target quantum system includes 10 particles, the cluster division is performed on the 10 particles included in the target quantum system to obtain multiple clusters, and each cluster includes at least one particle. For example, the 10 particles included in the target quantum system are divided into two clusters: a first cluster and a second cluster, where the first cluster includes 5 particles and the second cluster includes 5 particles. In another example, the 10 particles included in the target quantum system are divided into two clusters: a first cluster and a second cluster, where the first cluster includes 4 particles and the second cluster includes 6 particles.

Operation 120. Obtain multiple direct product states according to eigenstates respectively corresponding to multiple clusters.

In some embodiments, eigenstates corresponding to all clusters are solved, and then multiple direct product states are obtained according to eigenstates corresponding to all clusters in the multiple clusters.

In some embodiments, operation 120 may include the following sub-operations (1-3):

1. For a target cluster in the multiple clusters, acquire a reduced Hamiltonian of the target cluster.

The reduced Hamiltonian of the target cluster refers to a reduced representation of a real Hamiltonian of the target cluster. The reduced Hamiltonian of the target cluster can be obtained by solving the Hamiltonian of the target cluster in a current environment. In some embodiments, other clusters in the multiple clusters than the target cluster are used as an environment, and a Hamiltonian of the target cluster in the environment is acquired to obtain the reduced Hamiltonian of the target cluster.

For example, the target quantum system is divided into two clusters: a cluster A and a cluster B. For the cluster A, the cluster B is used as an environment, and the reduced Hamiltonian of the cluster A

$${H}_{A}^{α} = T {r}_{B} \left\{H {ρ}_{B}^{α}\right\}$$

can be obtained by partially tracing a specific quantum state

$${ρ}_{B}^{α} = \left|\left({φ}_{A}^{β}\right〉 \left〈{φ}_{A}^{β}\right)\right| ,$$

where α refers to a α^{th} quantum state of the cluster B, H refers to a Hamiltonian of the target quantum system, and the specific quantum state refers to a specific quantum state of the environment. Each quantum state of the environment corresponds to a reduced Hamiltonian of the cluster A. On the contrary, for the cluster B, the same method is also applicable. First, a quantum state of an isolated cluster A

$${ρ}_{A}^{β} = \left|\left({φ}_{A}^{β}\right〉 \left〈{φ}_{A}^{β}\right)\right|$$

is used as a quantum state of an environment, and then a reduced Hamiltonian

$${H}_{B}^{β} = T {r}_{A} \left\{H {ρ}_{A}^{β}\right\}$$

of the cluster B can be obtained, where β refers to a β^{th} quantum state of the cluster A, and H refers to the Hamiltonian of the target quantum system.

2. Acquire at least one eigenstate corresponding to the target cluster according to the reduced Hamiltonian of the target cluster.

In some embodiments, a ground state corresponding to the target cluster may be acquired according to the reduced Hamiltonian of the target cluster. In some embodiments, an excited state corresponding to the target cluster may further be acquired according to the reduced Hamiltonian of the target cluster.

In some embodiments, at least one eigenstate corresponding to the target cluster is acquired using a diagonalization algorithm according to the reduced Hamiltonian of the target cluster. In some embodiments, the diagonalization algorithm includes at least one of the following: a quantum eigenstate solving algorithm based on a variational method, a quantum eigenstate solving algorithm based on an adiabatic approximation, a quantum eigenstate solving algorithm based on an adiabatic shortcut, or a quantum eigenstate solving algorithm that combines the adiabatic approximation and the adiabatic shortcut.

For example, the target quantum system is divided into two clusters: a cluster A and a cluster B. A reduced Hamiltonian of the cluster A

$${H}_{A}^{α}$$

is diagonalized to obtain at least one eigenstate

$$\left\{\left|\left({φ}_{A}^{{i}_{α}}\right〉\right)\right\}$$

and eigenenergy

$$\left\{{ε}_{A}^{{i}_{α}}\right\} \left({H}_{A}^{α} = \sum {}_{i} {∈}_{A}^{{i}_{α}} \left|{φ}_{A}^{{i}_{α}} 〉 〈 {φ}_{A}^{{i}_{α}}\right|\right) ,$$

i refers to the i-th eigenstate/eigenenergy, and αrefers to a α^{th} quantum state of the cluster B. Similarly, the equivalent Hamiltonian of the cluster B

$${H}_{B}^{β}$$

is diagonalized

$${H}_{B}^{β} = \sum {}_{j} {ε}_{B}^{{j}_{β}} \left|{φ}_{B}^{{j}_{β}} 〉 〈 {φ}_{B}^{{j}_{β}}\right|$$

to obtain at least one eigenstate and eigenenergy, where j refers to a j^{th} eigenstate/eigenenergy, and β refers to a βth quantum state of the cluster A.

3. Perform a direct product operation on the eigenstates respectively corresponding to the multiple clusters to obtain multiple direct product states.

For example, the target quantum system is divided into two clusters: a first cluster and a second cluster, where the first cluster corresponds to 2 eigenstates and the second cluster corresponds to 2 eigenstates. The direct product operation is performed on a total of 4 eigenstates to obtain four direct product states.

Operation 130. Select some direct product states from the multiple direct product states as a set of basis vectors to represent a compressed Hilbert space.

In some embodiments, a dimension number of the compressed Hilbert space is less than that of an original Hilbert space of the target quantum system.

For example, if the target quantum system includes 10 particles, the dimension number of the original Hilbert space of the target quantum system is 2¹⁰, and the dimension number of the compressed Hilbert space needs to be less than 2¹⁰.

In some embodiments, associated direct product states are selected as a set of basis vectors to represent the compressed Hilbert space. The associated direct product states refer to direct product states with an orthogonal relation, that is, direct product states perpendicular to another state. The intention is that the determination of all direct product states is self-consistently convergent. For example,

$$\left\{\left|{φ}_{A}^{{i}_{α}} 〉\right)\right\} = \left\{\left|{φ}_{A}^{β} 〉\right)\right\}$$

and

$$\left\{\left|{φ}_{B}^{{i}_{β}} 〉\right)\right\} = \left\{\left|\left({φ}_{B}^{α}\right〉\right)\right\}$$

, where {x} represents a set, i refers to an i^{th} eigenstate/eigenenergy, αrefers to a α^{th} quantum state of the cluster B, and j refers to an j^{th} eigenstate/eigenenergy, and β refers to a β^{th} quantum state of the cluster A. However, if multiple states are considered, a regular recursive iteration is divergent.

Experiments show that by a recursive iteration, the number of the associated direct product states is usually constant. Therefore. a limited number of iterative operations are only needed to select the associated direct product states as a set of basis vectors to represent the compressed Hilbert space.

In some embodiments, operation 130 may include the following sub-operations (1-2):
1. Acquire energy values respectively corresponding to the multiple direct product states; and
2. Select multiple direct product states with the energy values meeting a condition from the multiple direct product states as a set of basis vectors to represent the compressed Hilbert space.

In some embodiments, n direct product states with the minimum energy value are selected from the multiple direct product states as a set of basis vectors to represent the compressed Hilbert space, and n is a positive integer. In some embodiments, n is a set number, and n direct product states may also be referred to as a set number of the direct product states. For example, the energy values of the multiple direct product states are sorted in ascending order, and the former set number of direct product states are selected as a set of basis vectors to represent the compressed Hilbert space. For example, the energy values of the multiple direct product states are sorted in descending order, and the latter set number of direct product states are selected as a set of basis vectors to represent the compressed Hilbert space. The set number refers to the set selection number for the direct product states, the former set number means that the direct product states sorted front are selected according to the set number during selection of the direct product states, and the latter set number means that the direct product states sorted back are selected according to the set number during selection of the direct product states. For example, assuming that the set number is 2, for the seven numbers 1, 2, 3, 4, 5, 6, and 7, the numbers selected according to the former set number are 1 and 2, and the numbers selected according to the latter set number are 6 and 7.

In some embodiments, some direct product states can be selected according to entanglement degrees of the multiple direct product states as a set of basis vectors to represent the compressed Hilbert space. The selection method of some direct product states is not limited herein. For example, a set number of direct product states with the minimum entanglement degree are selected from the multiple direct product states as a set of basis vectors to represent the compressed Hilbert space.

Operation 140. Acquire a Hamiltonian of the target quantum system and an equivalent Hamiltonian in the compressed Hilbert space.

The equivalent Hamiltonian refers to an equivalent representation of the Hamiltonian of the target quantum system. The eigenstate and eigenenergy of the equivalent Hamiltonian have the same eigenstate and eigenenergy as an original Hamiltonian of the target quantum system. Therefore, the eigenstate and eigenenergy of the target quantum system can be obtained by solving the eigenstate and eigenenergy of the equivalent Hamiltonian. However, because the equivalent Hamiltonian is the equivalent representation of the Hamiltonian of the target quantum system in the compressed Hilbert space, and a dimension number of the equivalent Hamiltonian is less than that of the original Hamiltonian of the target quantum system, the technical solutions of some embodiments can reduce the calculation amount required for acquiring the eigenstates.

Operation 150, Acquire an eigenstate and eigenenergy of the equivalent Hamiltonian as an eigenstate and eigenenergy of the target quantum system.

In some embodiments, the eigenstate and eigenenergy of the equivalent Hamiltonian are acquired using a diagonalization algorithm, where the diagonalization algorithm includes at least one of the following: a quantum eigenstate solving algorithm based on a variational method, a quantum eigenstate solving algorithm based on an adiabatic approximation, a quantum eigenstate solving algorithm based on an adiabatic shortcut, or a quantum eigenstate solving algorithm that combines the adiabatic approximation and the adiabatic shortcut. It can be learned from this that, in some embodiments, a suitable diagonalization algorithm can be selected according to an actual situation to acquire the eigenstate and eigenenergy of the target quantum system, so that the eigenstate acquisition solution of the quantum system provided in some embodiments can be applied to different situations, thereby improving the reliability and accuracy of acquiring the eigenstates of the quantum system.

For example, a ground state and ground state energy of the equivalent Hamiltonian are acquired by using the diagonalization algorithm. Further, the eigenstates such as a first excited state and a second excited state of the equivalent Hamiltonian and eigenenergy corresponding to each eigenstate can be solved based on the ground state of the equivalent Hamiltonian.

In summary, according to the technical solutions provided in some embodiments, the target quantum system is divided into the multiple clusters, the eigenstates of the multiple clusters are acquired to obtain the multiple direct product states, and some direct product states are selected from the multiple direct product states to construct the compressed Hilbert space, which reduces the dimension number of the Hilbert space. The eigenstate solving problem of the Hamiltonian of the high-dimensional system with multi-bit interaction is split into eigenstate solving problems of multiple low-dimensional Hamiltonians, so as to construct the compressed Hilbert space. The equivalent Hamiltonian of the Hamiltonian of the target quantum system in the compressed Hilbert space is calculated to obtain the eigenvalue and eigenenergy of the equivalent Hamiltonian as the eigenvalue and eigenenergy of the target quantum system. Because the dimension number of the compressed Hilbert space is less than that of the original Hilbert space of the target quantum system, in the digitization process, it is avoided that the required quantum gate operation increases rapidly with the increase of the dimension of the system, and that the number of gates for implementing multi-bit interaction increases rapidly with the increase of the dimensions of interaction, thereby reducing the calculation amount required for acquiring the eigenstates.

In addition, the multiple direct product states with the energy values meeting a condition are selected from the energy values corresponding to the multiple direct product states as a set of basis vectors to represent the compressed Hilbert space. On one hand, some direct product states are selected to construct the compressed Hilbert space, which reduces the dimension number of the Hilbert space. On the other hand, different conditions are set according to the actual situation to construct the compressed Hilbert space meeting different requirements, which makes more flexible and free construction of the compressed Hilbert space.

In addition, a set number of direct product states with the minimum energy value are selected from the multiple direct product states as a set of basis vectors to represent the compressed Hilbert space, which reduces the dimension number of the compressed Hilbert space as much as possible, thereby reducing the calculation amount required for acquiring the eigenstates and improving computation efficiency of the eigenstates.

In addition, for each of multiple clusters, at least one eigenstate corresponding to the cluster is acquired through a reduced Hamiltonian of the cluster. Then, multiple direct product states are obtained through a direct product operation on the eigenstate. That is, after the multiple clusters are obtained through division, each cluster is acquired and processed respectively to acquire multiple direct product states corresponding to each cluster, so that a subsequent selection result of direct product states is more accurate, thereby improving calculation accuracy of the eigenstate and eigenenergy of the target quantum system.

In addition, other clusters in the multiple clusters than the target cluster are used as an environment, and a Hamiltonian of the target cluster in the environment is acquired to obtain the reduced Hamiltonian of the target cluster. That is, during acquiring of the reduced Hamiltonian of the target cluster, a relationship between the target cluster and the remaining clusters is considered, so that the acquired reduced Hamiltonian of the target cluster is more accurate.

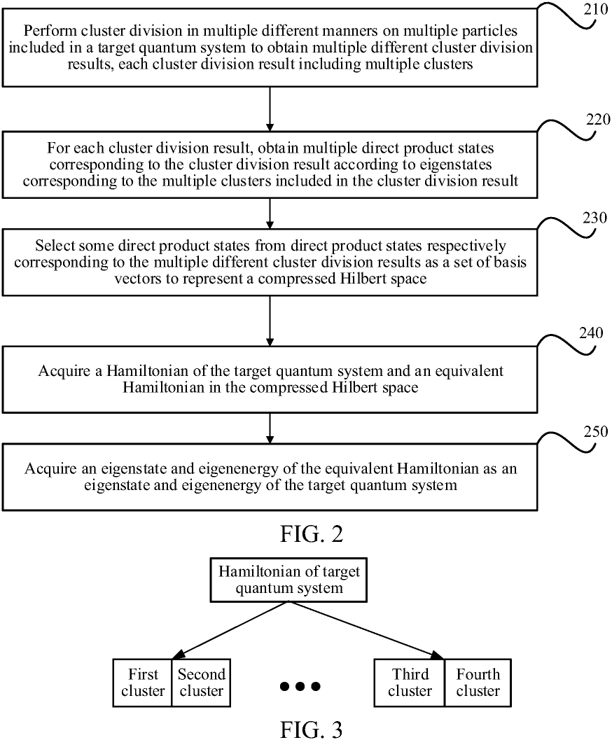

In some embodiments, there are multiple cluster division manners. FIG. 2 is a flowchart of a method for acquiring an eigenstate of a quantum system according to some embodiments. The method may include at least one of the following operations (210 to 250).

Operation 210. Perform cluster division in multiple different manners on multiple particles included in a target quantum system to obtain multiple different cluster division results, where each cluster division result includes multiple clusters.

For example, if the target quantum system includes 10 particles, the cluster division in multiple different manners is performed on the 10 particles included in the target quantum system to obtain multiple different cluster division results. For example, as shown in FIG. 3, the 10 particles included in the target quantum system can be divided into two clusters: a first cluster and a second cluster, where the first cluster includes 4 particles and the second cluster includes 6 particles; and the 10 particles included in the target quantum system can also be divided into two clusters: a third cluster and a fourth cluster, where the third cluster includes 5 particles and the fourth cluster includes 5 particles.

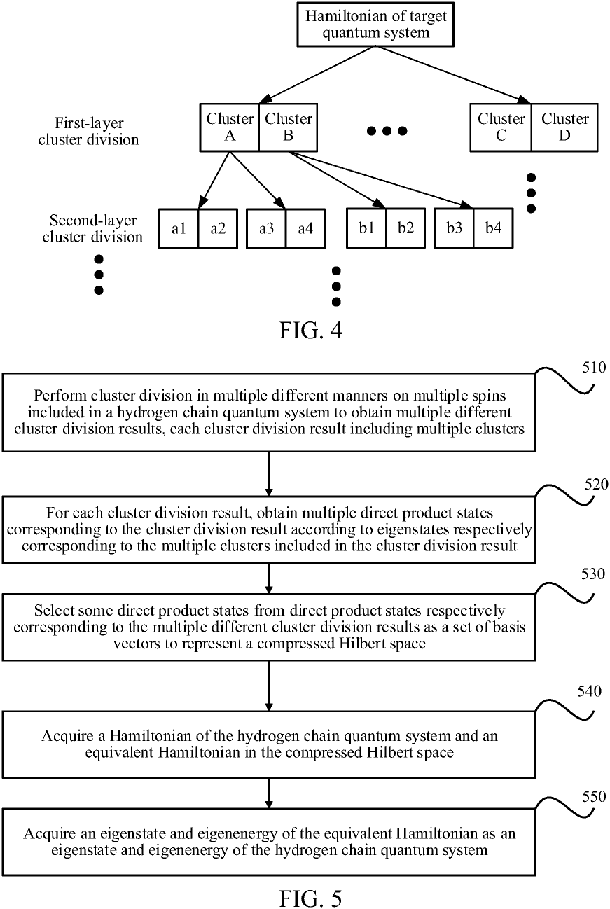

In some embodiments, the cluster division is performed on the multiple particles included in the target quantum system. For example, as shown in FIG. 4, first-layer cluster division is performed on the multiple particles included in the target quantum system to obtain two clusters: a cluster A and a cluster B, and then second-layer cluster division is performed on the cluster A and the cluster B to obtain clusters a1, a2, a3, and a4 and clusters b1, b2, b3, and b4.

The cluster division in multiple different manners is performed on the multiple particles included in the target quantum system are performed on to obtain multiple different cluster division results. Subsequent calculation for different cluster division results can consider an interaction between different particles and reduce errors, which improves the accuracy of acquiring the eigenstate of the quantum system.

Operation 220. For each cluster division result, obtain multiple direct product states corresponding to the cluster division result according to eigenstates respectively corresponding to the multiple clusters included in the cluster division result.

Eigenstates corresponding to all clusters included in the cluster division result are solved, and then multiple direct product states corresponding to the cluster division result are obtained according to eigenstates corresponding to all clusters in the multiple clusters.

Operation 230. Select some direct product states from direct product states respectively corresponding to the multiple different cluster division results as a set of basis vectors to represent a compressed Hilbert space.

For example, the target quantum system includes 10 particles, and a first division result is that the 10 particles included in the target quantum system are divided into two clusters: a first cluster and a second cluster, where the first cluster includes 5 particles and the second cluster includes 5 particles; a second division result is that the 10 particles included in the target quantum system are divided into two clusters: a third cluster and a fourth cluster, where the third cluster includes 4 particles and the fourth cluster includes 6 particles; a third division result is that the 10 particles included in the target quantum system are divided into two clusters: a fifth cluster and a sixth cluster, where the fifth cluster includes 4 particles and the sixth cluster includes 6 particles. At least one particle included in the fifth cluster is different from the particles included in the third cluster, and at least one particle included in the sixth cluster is different from the particles included in the fourth cluster.

From a direct product states respectively corresponding to the first division result, the second division result, and the third division result, some direct product states are selected as a set of basis vectors to represent the compressed Hilbert space.

In some embodiments, a set number of direct product states with the minimum energy value are selected from the multiple direct product states as a set of basis vectors to represent the compressed Hilbert space. For example, the energy values of the multiple direct product states are sorted in ascending order, and the former set number of direct product states are selected as a set of basis vectors to represent the compressed Hilbert space. For example, the energy values of the multiple direct product states are sorted in descending order, and the latter set number of direct product states are selected as a set of basis vectors to represent the compressed Hilbert space.

In some embodiments, from the direct product states respectively corresponding to the first division result, the second division result, and the third division result, a set number of direct product states with the minimum energy value are selected as a set of basis vectors to represent the compressed Hilbert space. For example, a set number of direct product states with the minimum energy value are selected from direct product states corresponding to the first division result to obtain a first set of direct product states, a set number of direct product states with the minimum energy value are selected from direct product states corresponding to the second division result to obtain a second set of direct product states, and a set number of direct product states with the minimum energy value are selected from direct product states corresponding to the third division result to obtain a third set of direct product states. The first set of direct product states, the second set of direct product states, and third set of direct product states are used as a set of basis vectors to represent the compressed Hilbert space.

In some embodiments, from all direct product states corresponding to the first division result, the second division result, and the third division result, a set number of direct product states with the minimum energy value are selected as a set of basis vectors to represent the compressed Hilbert space. In some embodiments, all direct product states corresponding to the first division result, the second division result, and the third division result are sorted in ascending order, the former set number of direct product states are selected as a set of basis vectors to represent the compressed Hilbert space.

In some embodiments, some direct product states can be selected according to entanglement degrees of the multiple direct product states as a set of basis vectors to represent the compressed Hilbert space. The selection method of some direct product states is not limited herein. For example, a set number of direct product states with the minimum entanglement degree are selected from the multiple direct product states as a set of basis vectors to represent the compressed Hilbert space.

Operation 240. Acquire a Hamiltonian of the target quantum system and an equivalent Hamiltonian in the compressed Hilbert space.

Operation 250. Acquire an eigenstate and eigenenergy of the equivalent Hamiltonian as an eigenstate and eigenenergy of the target quantum system.

Operations 240-250 in the method are the same as operations 140-150 shown in FIG. 1 in the foregoing method for acquiring an eigenstate of a quantum system. For details, reference may be made to the description above, and details are not described herein again.

In summary, according to the technical solutions provided in some embodiments, the cluster division in multiple different manners is performed on the multiple particles included in the target quantum system to obtain multiple different cluster division results, where each cluster division result includes the multiple clusters. The multiple direct product states are obtained according to eigenstates of the multiple clusters. Some direct product states are selected from direct product states respectively corresponding to the multiple different cluster division results as a set of basis vectors to represent the compressed Hilbert space. The direct product states obtained from the multiple cluster division results are combined to represent the compressed Hilbert space, which can reduce errors and improve the accuracy of acquiring the eigenstate of the quantum system.

Using an example in which the target quantum system is a hydrogen chain quantum system and a qubit is used to simulate a spin, the technical solution of some embodiments is described below. An original Hamiltonian of the hydrogen chain quantum system can be expressed as formula (3).

$$H = {\sum }_{i = 1}^{N} {g}_{1} {Z}_{i} + {\sum }_{i = 1}^{N - 1} {g}_{2} {X}_{i} {X}_{i + 1}$$

H represents the original Hamiltonian of the hydrogen chain quantum system, N represents the number of spins included in the hydrogen chain quantum system, Z represents a Pauli Z operator, and X represents a Pauli X operator, g₁ is a self-acting force of a single spin, and g₂ is an interaction force between two spins.

FIG. 5 is a flowchart of a method for acquiring an eigenstate of a quantum system according to some embodiments. The method may include at least one of the following operations (510 to 550).

Operation 510. Perform cluster division in multiple different manners on multiple spins included in a hydrogen chain quantum system to obtain multiple different cluster division results, where each cluster division result includes multiple clusters, each of the multiple clusters includes at least one spin.

For example, a length N of a hydrogen chain is 3<N<8 (n is a positive integer), and a relative size of an interaction between two spins (or qubits) is fixed at g₂/g₁ = 2, where g₂ is an interaction force between the two spins (or qubits) and g₁ is a self-acting force of a single spin (or qubit).

For example, cluster division in two cluster division manners is performed on the target quantum system according to {A={S₁,S₂}, B={S₃,...,S_{N}}} and {A′={_{S1},...,S_{N-2}}, B′={S_{N-} 1,...,S_{N}}}, where sᵢ refers to an i^{th} spin, and A, B, A′ and B′ respectively correspond to one cluster. A specific cluster division manner is not limited herein. Only two cluster division manners are used as an example herein for exemplary description.

Operation 520. For each cluster division result, obtain multiple direct product states corresponding to the cluster division result according to eigenstates respectively corresponding to the multiple clusters included in the cluster division result.

For example, four direct product states are obtained according to eigenstates respectively corresponding to the four clusters.

In some embodiments, at least one eigenstate corresponding to the target cluster is acquired according to the reduced Hamiltonian of the target cluster.

In some embodiments, at least one eigenstate corresponding to the target cluster is acquired using a diagonalization algorithm according to the reduced Hamiltonian of the target cluster. In some embodiments, the diagonalization algorithm includes, but is not limited to, at least one of the following: a quantum eigenstate solving algorithm based on a variational method, a quantum eigenstate solving algorithm based on an adiabatic approximation, a quantum eigenstate solving algorithm based on an adiabatic shortcut, or a quantum eigenstate solving algorithm that combines the adiabatic approximation and the adiabatic shortcut.

In some embodiments, a direct product operation is performed on eigenstates respectively corresponding to the multiple clusters to obtain multiple direct product states.

For example, using a cluster division manner of {A={S₁,S₂}, B={_{S3},...,_{SN}}} as an example, the cluster A is first used as a target cluster. Assuming that an initial state of the cluster B is

$$\left(\vert {φ}_{B}\right〉 ∝ \prod {}_{n = 3}^{N} {\left(\left(\vert +\right〉 + \left(\vert -\right〉\right)}_{n}$$

, the cluster B is used as an environment of the cluster A to obtain a reduced Hamiltonian of the cluster A, and the reduced Hamiltonian can be expressed as formula (4).

$${H}_{A} = {\overline{ε}}_{A} + {g}_{1} {Z}_{1} + {g}_{1} {Z}_{2} + {g}_{1}^{A} {X}_{2} + {g}_{2} {X}_{1} {X}_{2}$$

$${\overline{ε}}_{A} = {\sum }_{n = 3}^{N} {g}_{1} \left〈φ \left({}_{B}\right| Z \left({}_{n}\right| {φ}_{B}\right〉 , {g}_{1} A = {g}_{2} \left〈φ \left({}_{B}\right|\right) X \left({}_{3}\right| φ \left({}_{B}\right〉 ,$$

Z represents a Pauli Z operator, X represents a Pauli X operator, g₁ is the self-acting force of the single spin, g₂ is the interaction force between two spins, and N represents the number of spins included in the hydrogen chain quantum system.

For example, two eigenstates of H_{A}, a ground state and a first excited state, are obtained, and

$$\left\{\left|φ \left({}_{A}^{β}\right〉 = \left|φ \left({}_{A}^{g}\right〉 ,\right| φ \left({}_{A}^{e}\right〉\right)\right\} .$$

For example, a reduced Hamiltonian of two clusters B is obtained according to the ground state

$$\left|φ \left({}_{A}^{g}\right〉\right)$$

and the first excited state

$$\left|φ \left({}_{A}^{e}\right〉\right)$$

of the cluster A. The reduced Hamiltonian can be expressed as formula (5).

$${H}_{B}^{β} = {\overline{ε}}_{B} + {g}_{1}^{B} {X}_{3} + {\sum }_{n = 3}^{N} {g}_{1} {Z}_{n} + {\sum }_{n = 3}^{N - 1} {g}_{2} {X}_{n} {X}_{n + 1}$$

$${\overline{ε}}_{B} = {g}_{1} \left〈{φ}_{B} \left|{Z}_{1} + {Z}_{2}\right| {φ}_{B}\right〉 , {g}_{1}^{B} = {g}_{2} \left〈{φ}_{A}^{β} \left|{X}_{2}\right| {φ}_{A}^{β}\right〉 , β = \left\{g , e\right\} ,$$

Z represents a Pauli Z operator, X represents a Pauli X operator, g₁ is the self-acting force of the single spin, g₂ is the interaction force between two spins, and N represents the number of spins included in the hydrogen chain quantum system.

For example, four eigenstates (ground states and the first excited states)

$$\left|\left({φ}_{B}^{{j}_{β}}\right〉\right)$$

of two are obtained, where j={g,e}, and β= {g, e} .

For example, four eigenstates

$$\left|\left({φ}_{B}^{α}\right〉 , \left(α = {g}_{g} , {g}_{e} , {e}_{g} , {e}_{e}\right)\right)$$

of the cluster B are used as a state of an environment to obtain eight eigenstates (ground states and the first excited states)

$$\left|\left({φ}_{A}^{{i}_{α}}\right〉 , \left(i = g , e\right) , \left(α = {g}_{g} , {g}_{e} , {e}_{g} , {e}_{e}\right)\right)$$

of the cluster A.

To avoid further divergence of such recursion, only iterate to the third operation. The number of iterations is not limited herein, and only three iterations are used as an example herein for exemplary description.

For example, a direct product operation is performed on the eight eigenstates

$$( \left|\left({φ}_{A}^{{i}_{α}}\right〉 , \left(i = g , e\right) , \left(α = {g}_{g} , {g}_{e} , {e}_{g} , {e}_{e}\right)\right) )$$

of the cluster A and the four eigenstates

$$\left(\left|{φ}_{B}^{{i}_{β}} 〉 , j = \left\{g , e\right\} , β = \left\{g , e\right\}\right)\right)$$

of the cluster B to obtain eight direct product states.

For example, for a cluster division manner of {A′ = {s1, ..., sN-2}, B′ = {sN-1, ..., sN}}, eight eigenstates of the cluster A′ and four eigenstates of the cluster B′ can also be obtained according to the foregoing method, and the direct product operation is performed on the eight eigenstates to obtain eight direct product states.

Operation 530. Select some direct product states from direct product states respectively corresponding to the multiple different cluster division results as a set of basis vectors to represent a compressed Hilbert space.

For example, four direct product states

$$\left|{φ}_{A}^{{i}_{α}} 〉 ⊗ \left|{φ}_{B}^{α} 〉 , \left\{i = g , α = {g}_{g} , {g}_{e}\right\} ,\right)\right)$$

and {i = e, α = e₉, eₑ} are selected from the eight direct product states in the cluster A and the cluster B. Similarly, four direct product states are selected from the eight direct product states in the cluster A′ and the cluster B′. Schmidt orthogonalization is performed on a total of eight direct product states {|ψ_{γ=1},..., ₈>}, to obtain a set of basis vectors

$$\{ \left|{υ}_{y = 1 , ... , 8}^{S}\right) 〉 \text{\}}$$

to represent an eight-dimensional Hilbert space.

Operation 540. Acquire a Hamiltonian of the hydrogen chain quantum system and an equivalent Hamiltonian in the compressed Hilbert space.

For example, the Hamiltonian of the hydrogen chain quantum system and an equivalent Hamiltonian in the eight-dimensional Hilbert space are acquired. The equivalent Hamiltonian can be expressed as formula (6).

$${H}_{e f f} = {\sum }_{γ {γ}^{′}} {H}_{γ {γ}^{′}} \left|{υ}_{γ}^{S} 〉 〈 {υ}_{{γ}^{′}}^{S}\right|$$

$${H}_{γ {γ}^{′}} = 〈 {υ}_{γ}^{S} \left|H\right| {υ}_{{γ}^{′}}^{S} 〉 ,$$

H represents an original Hamiltonian of the hydrogen chain quantum system,

$$\left\{\left|{υ}_{γ}^{S} 〉\right)\right\}$$

is a basis vector obtained by the first cluster division manner, and

$$\left〈\left({υ}_{{γ}^{′}}^{S}\right|\right)$$

is a basis vector obtained the second cluster division manner.

Operation 550. Acquire an eigenstate and eigenenergy of the equivalent Hamiltonian as an eigenstate and eigenenergy of the hydrogen chain quantum system.

In some embodiments, the eigenstate and eigenenergy of the equivalent Hamiltonian are acquired using a diagonalization algorithm, where the diagonalization algorithm includes at least one of the following: a quantum eigenstate solving algorithm based on a variational method, a quantum eigenstate solving algorithm based on an adiabatic approximation, a quantum eigenstate solving algorithm based on an adiabatic shortcut, or a quantum eigenstate solving algorithm that combines the adiabatic approximation and the adiabatic shortcut.

For example, using the quantum eigenstate solving algorithm that combines the adiabatic approximation and the adiabatic shortcut is the diagonalization algorithm as an example, the eigenstate and eigenenergy of the equivalent Hamiltonian are acquired.

For example, in the quantum eigenstate solving algorithm based on an adiabatic approximation, one quantum system evolves with an instantaneous eigenstate of the quantum system. For an equivalent Hamiltonian Heff, an initial Hamiltonian H₀ is selected, and then an adiabatic Hamiltonian varying with time is designed. The adiabatic Hamiltonian can be expressed as formula (7).

$${H}_{a d} \left(t\right) = {H}_{0} + λ \left(t\right) \left({H}_{e f f} - {H}_{0}\right)$$

λ(t) satisfies λ(t = 0) = 0 at the initial time and λ(t = T) = 1 at the last time. If the initial state of the quantum system is prepared in the eigenstate, that is,

$$\left|Ψ \left(\left(t = 0\right)\right〉 =\right| {φ}_{n} \left(\left({H}_{0}\right)\right〉 ,$$

in the case of

$$\left|\dot{λ} \left(t\right)\right| \to 0 ,$$

the quantum system gradually evolves to an eigenstate corresponding to the equivalent Hamiltonian, and

$${lim}_{T \to } \left|Ψ \left(\left(t = T\right)\right〉 =\right| \left({φ}_{n} \left(H\right)\right〉 .$$

In fact, if a distance is close enough,

$$\left〈{δ}_{{φ}_{n}}\right) \left|\left({δ}_{{φ}_{n}}\right〉 < < 1 , \left|\left({δ}_{{φ}_{n}}\right〉 = \left|{φ}_{n} \left(\left(H\right)\right〉 - \left|{φ}_{n}\right) \left(\left({H}_{0}\right)\right〉\right)\right)\right) ,$$

an evolution time T can also be small enough.

For example, in the quantum eigenstate solving algorithm based on an adiabatic approximation, an anti-adiabatic Hamiltonian needs to be introduced, and the anti-adiabatic Hamiltonian can be expressed as formula (8).

$$\begin{matrix}{H}_{c d} \left(t\right) = \\ i {\sum }_{n} \left[\left|{\dot{φ}}_{n} \left(\left(t\right)\right〉 〈 {φ}_{n} \left(t\right)\right| - \left〈{φ}_{n} \left(t\right) \left|{\dot{φ}}_{n} \left(\left(t\right)\right〉\right| {φ}_{n} \left(\left(t\right)\right〉 \left〈{φ}_{n} \left(\left(t\right)\right|\right)\right)\right]\end{matrix}$$

$$\left|{φ}_{n} \left(\left(t\right)\right〉 ≡\right| {φ}_{n} \left(\left({H}_{a d}\right\} \left(t\right)\right) 〉$$

is an instantaneous eigenstate of the adiabatic Hamiltonian H_{ad} (t) at time t. Therefore, a quantum system with a Hamiltonian Hₜₒₜ (t)= H_{ad} (t)+ H_{cd} (t), in the case of

$$\dot{λ} \left(t = 0\right) = 0 \text{and} \dot{λ} \left(t = T\right) = 0 ,$$

is strictly in the eigenstate

$$\left|Ψ \left(\left(t = T\right)\right〉 =\right| {φ}_{n} \left(\left(H\right)\right〉$$

at any operation time. In fact, the anti-adiabatic Hamiltonian can be approximately estimated by single-bit approximation or commutative term expansion.

Unless the distance is close enough, an adiabatic evolution takes a lot of time or operations, and a fast adiabatic term of an adiabatic shortcut method is complex. Therefore, the adiabatic evolution and the adiabatic shortcut method are combined. Using a reduced Hamiltonian of formula (3) as an example, an initial Hamiltonian

$${H}_{A}^{0} = {\overline{ε}}_{A} + {g}_{1} {Z}_{1} + {g}_{1} {Z}_{2}$$

is selected and two intermediate reference point Hamiltonians

$${H}_{A}^{\text{i=1,2}}$$

are designed. The intermediate reference point Hamiltonian can be expressed as formula (9).

$${H}_{A}^{i} = {H}_{A} \left({λ}_{1}^{i} , {λ}_{2}^{i}\right) = {H}_{A}^{0} + {λ}_{1}^{i} {g}_{1}^{A} {X}_{2} + {λ}_{2}^{i} {g}_{2}^{A} {X}_{1} {X}_{2}$$

$$\left\{{λ}_{1}^{1} = 0 , {λ}_{2}^{1} = 0.1\right\} , \left\{{λ}_{1}^{2} = 0.5 , {λ}_{2}^{2} = 0.5\right\} ,$$

and X represents a Pauli X operator.

For example, parameters of the initial Hamiltonian and the reduced Hamiltonian can also be included:

$$\left\{{λ}_{1}^{0} = 0 , {λ}_{2}^{0} = 0\right\} , \text{and} \left\{{λ}_{1}^{3} = 1 , {λ}_{2}^{3} = 1\right\} .$$

Therefore, there are three evolutionary processes in the leapfrog process herein. The adiabatic Hamiltonian evolved in each section can be designed as formula (10).

$$\begin{matrix}{H}_{A ; a d}^{i} \left({t}_{i}\right) = {H}_{A} \left({λ}_{1}^{i} \left({t}_{i}\right) , {λ}_{2}^{i} \left({t}_{i}\right)\right) = {H}_{A}^{0} + {λ}_{0}^{i} \left({t}_{i}\right) {g}_{1}^{A} {X}_{2} + \\ {λ}_{2}^{i} \left({t}_{i}\right) {g}_{2}^{A} {X}_{1} {X}_{2}\end{matrix}$$

$${λ}_{j = 1 , 2}^{i} \left({t}_{i}\right) = {λ}_{j}^{i - 1} + \left({λ}_{j}^{i} - {λ}_{j}^{i - 1}\right) η \left({t}_{i}\right) ,$$

and X represents a Pauli X operator. A time function is

$$η \left(0 ⩽ {t}_{i} ⩽ {T}_{i}\right) = {\text{sin}}^{2} \left(π {t}_{i} / 2 {T}_{i}\right) .$$

Tᵢ is an evolution time of an i^{th} section. If the initial state is prepared on the ground state of

$${H}_{A}^{0} ,$$

the trajectory of the leapfrog process is:

$$\left\{\begin{matrix}\left(\text{First section} \text{} \text{:} \text{\textbar} {φ}_{A}^{9} \left({H}_{A}^{0}\right)\right〉 \to \left(\vert {φ}_{A}^{9} \left({H}_{A}^{1}\right)\right〉 , & \text{Evolution in adiabatic shortcut method} \\ \text{Second section:} \left(\text{\textbar} {φ}_{A}^{9} \left({H}_{A}^{1}\right)\right〉 \to \left(\vert {φ}_{A}^{9} \left({H}_{A}^{2}\right)\right〉 , & \text{Adiabatic evolution} \\ \text{Third section} \left(\text{:} \text{\textbar} {φ}_{A}^{9} \left({H}_{A}^{2}\right)\right〉 \to \left(\vert {φ}_{A}^{9} \left({H}_{A}\right)\right〉 , & \text{Adiabatic evolution}\end{matrix}\right)$$

The eigenstate

$$\left(\left|{Ψ}_{g}^{t h e o r}\right)\right〉$$

and eigenenergy

$${E}_{g}^{t h e o r}$$

of the equivalent Hamiltonian are acquired as the eigenstate and eigenenergy of the hydrogen chain quantum system.

For example, for a hydrogen chain of N>4, a calculation space can be limited to a Hamiltonian of hydrogen chains

$${N}^{′} ⩽ \text{4}$$

by using multi-layer cluster division. For example, an 8-spin hydrogen chain can be decomposed into a Hamiltonian of 50 2-spin hydrogen chains, 5 3-spin hydrogen chains, and 16 4-spin hydrogen chains for calculation. A size of the calculation space is not limited herein. Only a Hamiltonian of the hydrogen chain of

$${N}^{′} ⩽ \text{4}$$

is used as an example herein for exemplary description.

Some embodiments have experimentally verified the acquisition of the eigenstate of the hydrogen chain quantum system with the length N of the hydrogen chain

$$3 ⩽ N ⩽ 8$$

and the relative size of the two-bit interaction fixed at g₂/g₁=2. The result of the accuracy

$${F}_{g}^{t h e o r}$$

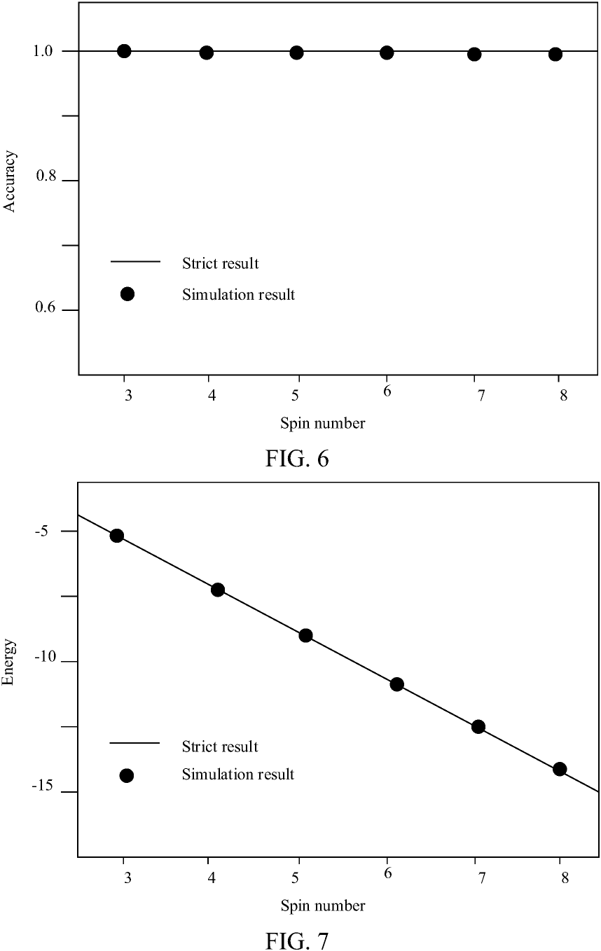

of the ground state |ψ_{g}〉 is shown in FIG. 6 and the result of the ground state energy

$${E}_{g}^{t h e o r}$$

is shown in FIG. 7.

In order to measure the accuracy of the method for acquiring an eigenstate of a quantum system in some embodiments, an accuracy function is defined:

$${F}_{g}^{t h e o r} = \left|〈 Ψ \left({}_{g}^{e x c}\right|\right) Ψ {\left({}_{g}^{t h e o r} 〉\right|}^{∧} 2 \text{.} {Ψ}_{g}^{t h e o r}$$

is a result obtained by numerical calculation,

$${Ψ}_{g}^{e x a c t}$$

is a strict result, and the strict result is obtained by a classical singular value decomposition algorithm on the classic computer. As shown in FIG. 6, the results obtained by the method for acquiring an eigenstate of a quantum system some embodiments are accurate, and

$${F}_{g}^{t h e o r} ( 3 ⩽ N ⩽ 8 ) > 99.4 \%$$

. As shown in FIG. 7, the accuracy of the ground state energy

$${E}_{g}^{t h e o r}$$

is even higher (>99.9%).

In addition, some embodiments also experimentally implement the method for acquiring an eigenstate method of a quantum system in a superconducting qubit system. For example, a Hamiltonian form of a 3-spin chain quantum system with 3-spin interaction is shown in formula (11).

$$H = {g}_{1} \left({Z}_{1} + {Z}_{2} + {Z}_{3}\right) + {g}_{2} \left({X}_{1} {X}_{2} + {X}_{2} {X}_{3}\right) + {g}_{3} {X}_{1} {X}_{2} {X}_{3}$$

Two sets of experiments were performed. The first set of experiments included fixing the relative size of the 3-spin interaction g₃/g₁ = 0.1 and changing the size of the 2-spin interaction g_{2/}g₁ from 0 to 2.0 to obtain the ground state accuracy

$${F}_{g}^{t h e o} > 99 \%$$

Fg^{theo} > 99% , and

$${F}_{g}^{exp} > 95 \%$$

$${F}_{g}^{t h e o}$$

F_{g}^{exp} > 95%. Fg^{theo} refers to the ground state accuracy obtained by numerical simulation of the whole process on a classic computer; and

$${F}_{g}^{exp}$$

F_{g}^{exp} refers to the ground state accuracy that is obtained finally by implementing a diagonalization process of clusters and equivalent Hamiltonian H_{eff} on

$${H}_{e f f}$$

qubits.

The second set of experiments included fixing the relative size of the 2-spin interaction g₂/g₁=2.0 and changing the size of the 3-spin interaction g₃/g₁ from 0 to 2.0 to obtain the ground state accuracy F_{g}^{theo} > 97%

$${F}_{g}^{t h e o} > 97 \%$$

, and F₉^{exp} > 95 %

$${F}_{g}^{exp} > 95 \%$$

$${F}_{g}^{t h e o}$$

. Fg^{theo} refers to the ground state accuracy obtained by numerical simulation of the whole process on a classic computer; and F₉^{exp}

$${F}_{g}^{exp}$$

refers to the ground state accuracy that is obtained finally by implementing a diagonalization process of clusters and equivalent Hamiltonian H_{eff}

$${H}_{e f f}$$

on qubits.

In summary, according to the technical solutions provided in some embodiments, using the hydrogen chain quantum system with a hydrogen chain length 3 < N < 8

$$3 ⩽ N ⩽ 8$$

as an example, the derivation and the experimental verification are performed. Through the experimental data, it is verified that the accuracy of the method for acquiring an eigenstate of a quantum system in some embodiments is high, and the hydrogen chain quantum system is used for verification, which proves that the method has general applicability.

The following is an apparatus provided in some embodiments, which can be used to perform the method provided in some embodiments. For details not disclosed in the apparatus embodiments, refer to the method embodiments.

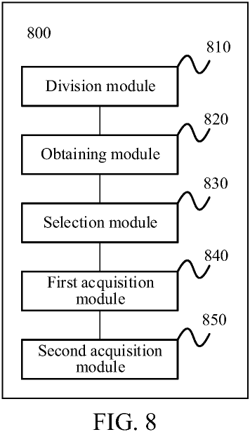

FIG. 8 is a block diagram of an apparatus for acquiring an eigenstate of a quantum system according to some embodiments. The apparatus 800 may include: a division module 810, an obtaining module 820, a selection module 830, a first acquisition module 840, and a second acquisition module 850.

The division module 810 is configured to perform cluster division on multiple particles included in a target quantum system to obtain multiple clusters, each of the multiple clusters including at least one particle.

The obtaining module 820 is configured to obtain multiple direct product states according to eigenstates respectively corresponding to the multiple clusters.

The selection module 830 is configured to select some direct product states from the multiple direct product states as a set of basis vectors to represent a compressed Hilbert space, a dimension number of the compressed Hilbert space being less than that of an original Hilbert space of the target quantum system.

In some embodiments, the selection module 830 is configured to select some direct product states from direct product states respectively corresponding to the multiple different cluster division results as a set of basis vectors to represent the compressed Hilbert space.

The first acquisition module 840 is configured to acquire a Hamiltonian of the target quantum system and an equivalent Hamiltonian in the compressed Hilbert space.

The second acquisition module 850 is configured to acquire an eigenstate and eigenenergy of the equivalent Hamiltonian as an eigenstate and eigenenergy of the target quantum system.

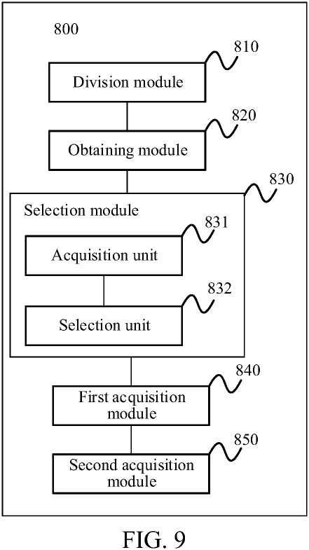

In some embodiments, as shown in FIG. 9, the selection module 830 includes an acquisition unit 831 and a selection unit 832.

The acquisition unit 831 is configured to acquire energy values respectively corresponding to the multiple direct product states.

The selection unit 832 is configured to select multiple direct product states with the energy values meeting a condition from the multiple direct product states as a set of basis vectors to represent the compressed Hilbert space.

In some embodiments, the selection unit 832 is configured to select n direct product states with the minimum energy value from the multiple direct product states as a set of basis vectors to represent the compressed Hilbert space, and n is a positive integer.

In some embodiments, the obtaining module 820 is configured to, for a target cluster in the multiple clusters, acquire a reduced Hamiltonian of the target cluster; acquire at least one eigenstate corresponding to the target cluster according to the reduced Hamiltonian of the target cluster; and perform a direct product operation on eigenstates respectively corresponding to the multiple clusters to obtain the multiple direct product states.

In some embodiments, the first acquisition module 840 is configured to use other clusters in the multiple clusters than the target cluster as an environment, and acquire a Hamiltonian of the target cluster in the environment to obtain the reduced Hamiltonian of the target cluster.

In some embodiments, the division module 810 is configured to perform cluster division in multiple different manners on the multiple particles included in the target quantum system to obtain multiple different cluster division results, where each cluster division result includes multiple clusters.

In some embodiments, the second acquisition module 850 is configured to acquire the eigenstate and eigenenergy of the equivalent Hamiltonian using a diagonalization algorithm, where the diagonalization algorithm includes at least one of the following: a quantum eigenstate solving algorithm based on a variational method, a quantum eigenstate solving algorithm based on an adiabatic approximation, a quantum eigenstate solving algorithm based on an adiabatic shortcut, or a quantum eigenstate solving algorithm that combines the adiabatic approximation and the adiabatic shortcut; and determine the eigenstate and eigenenergy of the equivalent Hamiltonian as the eigenstate and eigenenergy of the target quantum system.

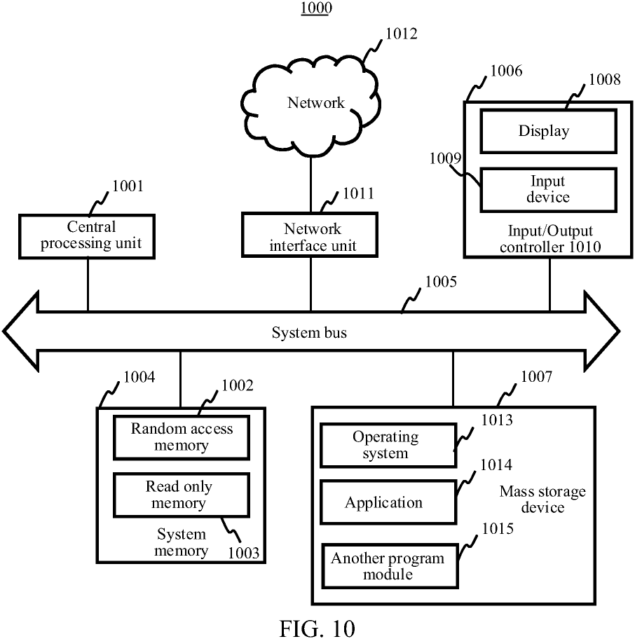

FIG. 10 is a structural block diagram of a computer device 1000 according to some embodiments. The computer device 1000 may be a classic computer. The computer device may be configured to implement the method for acquiring an eigenstate of a quantum system provided in the foregoing embodiments. Specifically,

the computer device 1000 includes a processing unit 1001 (such as a central processing unit (CPU), a graphics processing unit (GPU), and a field programmable gate array (FPGA)), a system memory 1004 including a random-access memory 1002 (RAM) and a read-only memory 1003, and a system bus 1005 connecting the system memory 1004 and the central processing unit 1001. The computer device 1000 further includes a basic input/output system (I/O system) 1006 configured to transmit information between components in the server, and a mass storage device 1007 configured to store an operating system 1013, an application program 1014, and another program module 1015.

In some embodiments, the basic I/O system 1006 includes a display 1008 configured to display information and an input device 1009, such as a mouse or a keyboard, configured to input information for a user. The display 1008 and the input device 1009 are both connected to the CPU 1001 by using an input/output controller 1010 connected to the system bus 1005. The basic I/O system 1006 may further include the I/O controller 1010 configured to receive and process inputs from multiple other devices such as a keyboard, a mouse, or an electronic stylus. Similarly, the input/output controller 1010 further provides output to a display screen, a printer, or other types of output devices.

In some embodiments, the mass storage device 1007 is connected to the CPU 1001 by using a mass storage controller (not shown) connected to the system bus 1005. The mass storage device 1007 and an associated computer-readable medium provide non-volatile storage for the computer device 1000. That is, the mass storage device 1007 may include a computer-readable medium (not shown) such as a hard disk or a compact disc read-only memory (CD-ROM) drive.

Without loss of generality, the computer-readable medium may include a computer storage medium and a communication medium. The computer storage medium comprises volatile and non-volatile, removable and non-removable media that are configured to store information such as computer-readable instructions, data structures, program modules, or other data and that are implemented by using any method or technology. The computer storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art can know that the computer storage medium is not limited to the foregoing several types. The foregoing system memory 1004 and mass storage device 1007 may be collectively referred to as a memory.

According to some embodiments, the computer device 1000 may further be connected, through a network such as the Internet, to a remote computer on the network. That is, the computer device 1000 may be connected to a network 1012 by using a network interface unit 1011 connected to the system bus 1005, or may be connected to another type of network or a remote computer system (not shown) by using a network interface unit 1011.

The memory further includes at least one instruction, at least one program, a code set, or an instruction set, the at least one instruction, the at least one program, the code set or the instruction set being stored in the memory and configured to be executed by one or more processors to implement the foregoing method for acquiring an eigenstate of a quantum system.

A person skilled in the art may understand that the structure shown in FIG. 10 does not constitute any limitation on the computer device 1000, and the computer device may include more components or fewer components than those shown in the figure, or some components may be combined, or a different component deployment may be used.

In some embodiments, a non-transitory computer-readable storage medium is further provided, the storage medium storing at least one instruction, at least one program, a code set or an instruction set, the at least one instruction, the at least one program, the code set or the instruction set, when executed by a processor, implementing the foregoing method for acquiring an eigenstate of a quantum system.

In some embodiments, the computer-readable storage medium may include: a read-only memory (ROM), a RAM, a solid state drive (SSD), an optical disc, or the like. The RAM may include a resistance random access memory (ReRAM) and a dynamic random access memory (DRAM).

In some embodiments, a computer program product or a computer program is further provided. The computer program product or the computer program includes computer instructions, and the computer instructions are stored in a computer-readable storage medium. A processor of a computer device reads the computer instructions from the computer-readable storage medium, and executes the computer instructions, to cause the computer device to perform the foregoing method for acquiring an eigenstate of a quantum system.

What is claimed is:

1. A method for acquiring an eigenstate of a quantum system, performed by a computer device, the method comprising:
performing cluster division on multiple particles comprised in a target quantum system to obtain multiple clusters, each of the multiple clusters comprising at least one particle;
obtaining multiple direct product states according to eigenstates respectively corresponding to the multiple clusters;
selecting a set of direct product states from the multiple direct product states as a set of basis vectors to represent a compressed Hilbert space, a dimension number of the compressed Hilbert space being less than that of an original Hilbert space of the target quantum system;
acquiring a Hamiltonian of the target quantum system and an equivalent Hamiltonian in the compressed Hilbert space; and
acquiring an eigenstate and eigenenergy of the equivalent Hamiltonian as an eigenstate and eigenenergy of the target quantum system.

2. The method according to claim 1, wherein the selecting comprises:
acquiring energy values respectively corresponding to the multiple direct product states; and
selecting multiple direct product states with the energy values meeting a condition from the multiple direct product states as a set of basis vectors to represent the compressed Hilbert space.

3. The method according to claim 2, wherein the selecting multiple direct product states comprises:
selecting n direct product states with the minimum energy value from the multiple direct product states as a set of basis vectors to represent the compressed Hilbert space, and n is a positive integer.

4. The method according to claim 1, wherein the obtaining comprises:
for a target cluster in the multiple clusters, acquiring a reduced Hamiltonian of the target cluster;
acquiring at least one eigenstate corresponding to the target cluster according to the reduced Hamiltonian of the target cluster; and
performing a direct product operation on the eigenstates respectively corresponding to the multiple clusters to obtain the multiple direct product states.

5. The method according to claim 4, wherein the acquiring a reduced Hamiltonian of the target cluster comprises:
using other clusters in the multiple clusters than the target cluster as an environment, and acquiring a Hamiltonian of the target cluster in the environment to obtain the reduced Hamiltonian of the target cluster.

6. The method according to claim 1, wherein the performing comprises:
performing cluster division in multiple different manners on the multiple particles comprised in the target quantum system to obtain multiple different cluster division results, wherein each cluster division result comprises multiple clusters; and
the selecting a set of direct product states from the multiple direct product states as a set of basis vectors to represent a compressed Hilbert space comprises:
selecting the set of direct product states from direct product states respectively corresponding to the multiple different cluster division results as the set of basis vectors to represent the compressed Hilbert space.

7. The method according to claim 1, wherein the acquiring the eigenstate and eigenenergy of the equivalent Hamiltonian as an eigenstate and eigenenergy of the target quantum system comprises:
acquiring the eigenstate and eigenenergy of the equivalent Hamiltonian using a diagonalization algorithm, wherein the diagonalization algorithm comprises at least one of the following: a quantum eigenstate solving algorithm based on a variational method, a quantum eigenstate solving algorithm based on an adiabatic approximation, a quantum eigenstate solving algorithm based on an adiabatic shortcut, or a quantum eigenstate solving algorithm that combines the adiabatic approximation and the adiabatic shortcut; and
determining the eigenstate and eigenenergy of the equivalent Hamiltonian as the eigenstate and eigenenergy of the target quantum system.

8. An apparatus for acquiring an eigenstate of a quantum system, comprising:
at least one memory configured to store program code; and
at least one processor configured to read the program code and operate as instructed by the program code, the program code comprising:
division code configured to cause at least one of the at least one processor to perform cluster division on multiple particles comprised in a target quantum system to obtain multiple clusters, each of the multiple clusters comprising at least one particle;
obtaining code configured to cause at least one of the at least one processor to obtain multiple direct product states according to eigenstates respectively corresponding to the multiple clusters;
selection code configured to cause at least one of the at least one processor to select a set of direct product states from the multiple direct product states as a set of basis vectors to represent a compressed Hilbert space, a dimension number of the compressed Hilbert space being less than that of an original Hilbert space of the target quantum system;
first acquisition code configured to cause at least one of the at least one processor to acquire a Hamiltonian of the target quantum system and an equivalent Hamiltonian in the compressed Hilbert space; and
second acquisition code configured to cause at least one of the at least one processor to acquire an eigenstate and eigenenergy of the equivalent Hamiltonian as an eigenstate and eigenenergy of the target quantum system.

9. The apparatus according to claim 8, wherein the selection module is further configured to cause at least one of the at least one processor to:
acquire energy values respectively corresponding to the multiple direct product states; and
select multiple direct product states with the energy values meeting a condition from the multiple direct product states as a set of basis vectors to represent the compressed Hilbert space.

10. The apparatus according to claim 9, wherein the selection code is further configured to cause at least one of the at least one processor to select n direct product states with the minimum energy value from the multiple direct product states as a set of basis vectors to represent the compressed Hilbert space, and n is a positive integer.

11. The apparatus according to claim 8, wherein the obtaining code is further configured to cause at least one of the at least one processor to:
for a target cluster in the multiple clusters, acquire a reduced Hamiltonian of the target cluster;
acquire at least one eigenstate corresponding to the target cluster according to the reduced Hamiltonian of the target cluster; and
perform a direct product operation on the eigenstates respectively corresponding to the multiple clusters to obtain the multiple direct product states.

12. The apparatus according to claim 11, wherein the first acquisition code is further configured to cause at least one of the at least one processor to use other clusters in the multiple clusters than the target cluster as an environment, and acquire a Hamiltonian of the target cluster in the environment to obtain the reduced Hamiltonian of the target cluster.

13. The apparatus according to claim 8, wherein
the division code is further configured to cause at least one of the at least one processor to perform cluster division in multiple different manners on the multiple particles comprised in the target quantum system to obtain multiple different cluster division results, wherein each cluster division result comprises multiple clusters; and
the selection code is further configured to cause at least one of the at least one processor to select the set of direct product states from direct product states respectively corresponding to the multiple different cluster division results as a set of basis vectors to represent the compressed Hilbert space.

14. The apparatus according to claim 8, wherein the second acquisition code is further configured to cause at least one of the at least one processor to:
acquire the eigenstate and eigenenergy of the equivalent Hamiltonian using a diagonalization algorithm, wherein the diagonalization algorithm comprises at least one of the following: a quantum eigenstate solving algorithm based on a variational method, a quantum eigenstate solving algorithm based on an adiabatic approximation, a quantum eigenstate solving algorithm based on an adiabatic shortcut, or a quantum eigenstate solving algorithm that combines the adiabatic approximation and the adiabatic shortcut; and
determine the eigenstate and eigenenergy of the equivalent Hamiltonian as the eigenstate and eigenenergy of the target quantum system.

15. A non-transitory computer-readable storage medium, storing computer code that, when executed by at least one processor, causes the at least one processor to at least:
perform cluster division on multiple particles comprised in a target quantum system to obtain multiple clusters, each of the multiple clusters comprising at least one particle;
obtain multiple direct product states according to eigenstates respectively corresponding to the multiple clusters;
select a set of direct product states from the multiple direct product states as a set of basis vectors to represent a compressed Hilbert space, a dimension number of the compressed Hilbert space being less than that of an original Hilbert space of the target quantum system;
acquire a Hamiltonian of the target quantum system and an equivalent Hamiltonian in the compressed Hilbert space; and
acquire an eigenstate and eigenenergy of the equivalent Hamiltonian as an eigenstate and eigenenergy of the target quantum system.

16. The non-transitory computer-readable storage medium according to claim 15, wherein the select comprises:
acquiring energy values respectively corresponding to the multiple direct product states; and
selecting multiple direct product states with the energy values meeting a condition from the multiple direct product states as a set of basis vectors to represent the compressed Hilbert space.

17. The non-transitory computer-readable storage medium according to claim 16, wherein the selecting multiple direct product states comprises:
selecting n direct product states with the minimum energy value from the multiple direct product states as a set of basis vectors to represent the compressed Hilbert space, and n is a positive integer.

18. The non-transitory computer-readable storage medium according to claim 15, wherein the obtain comprises:
for a target cluster in the multiple clusters, acquiring a reduced Hamiltonian of the target cluster;
acquiring at least one eigenstate corresponding to the target cluster according to the reduced Hamiltonian of the target cluster; and
performing a direct product operation on the eigenstates respectively corresponding to the multiple clusters to obtain the multiple direct product states.

19. The non-transitory computer-readable storage medium according to claim 18, wherein the acquiring a reduced Hamiltonian of the target cluster comprises:
using other clusters in the multiple clusters than the target cluster as an environment, and acquiring a Hamiltonian of the target cluster in the environment to obtain the reduced Hamiltonian of the target cluster.

20. The non-transitory computer-readable storage medium according to claim 15, wherein the perform comprises:
performing cluster division in multiple different manners on the multiple particles comprised in the target quantum system to obtain multiple different cluster division results, wherein each cluster division result comprises multiple clusters; and
the selecting a set of direct product states from the multiple direct product states as a set of basis vectors to represent a compressed Hilbert space comprises:
selecting the set of direct product states from direct product states respectively corresponding to the multiple different cluster division results as the set of basis vectors to represent the compressed Hilbert space.
